(19) United States
(12) Patent Application Publication
(10) Pub. No.: US 2022/0237875 A1
(43) Pub. Date: Jul. 28, 2022

(54) METHODS AND APPARATUS FOR ADAPTIVE AUGMENTED REALITY ANCHOR GENERATION

(71) Applicant: Google LLC, Mountain View, CA (US)

(72) Inventors: Shengzhi Wu, (US); Anshuman Kumar, Redwood City, CA (US)

(21) Appl. No.: 17/310,140

(22) PCT Filed: Jul. 22, 2020
(86) PCT No.: PCT/US2020/070301

§ 371 Date: Jul. 20, 2021

(51) Int. Cl. G06T 19/00; G06T 11/20; G06V 20/20

(52) U.S. Cl. CPC G06T 19/006; G06V 20/20; G06T 11/203

(57) ABSTRACT

In one general aspect, a method can include detecting a surface within a real-world area where the surface is captured by a user via an image sensor in a mobile device. The method can include receiving an augmented reality (AR) generation instruction to generate an AR anchor intersecting the surface within the real-world area where the AR anchor is at a target location for display of an AR object. The method can include defining a capture instruction, in response to the AR generation instruction and based on the intersection.

### BACKGROUND

Placing an augmented reality (AR) object in the proper context within an image of a real-world scene viewed through a mobile device of a user can be complicated. Specifically, placing the AR object in the proper location and/or orientation within the display can be difficult to achieve.

### SUMMARY

This document describes methods and apparatuses for generating an AR anchor.

In an aspect, a method, comprising: detecting a surface within a real-world area, the surface being captured by a user via an image sensor in a mobile device; receiving an AR generation instruction to generate an augmented reality (AR) anchor intersecting the surface within the real-world area, the AR anchor being at a target location for display of an AR object; and defining a capture instruction, in response to the AR generation instruction and based on the intersection. The AR anchor intersecting the surface may include an AR generation area associated with the AR anchor intersecting the surface. The AR generation area may include a capture path to capture the AR anchor. The defined capture instruction may define the AR generation area. Also, the defining the capture instruction may include modifying the capture instruction from a default capture instruction. Further, the capture instruction may include a capture arc. The capture arc may be less than 360 degrees. Also, the capture instruction may be displayed within an adaptive AR placement user interface. The surface can be a first surface, and the method may further comprise: detecting a second surface within the real-world area, the defining of the capture instruction being based on the first surface and the second surface. Also, the capture instruction may include a capture arc less than 180 degrees based on the first surface and the second surface.

In another aspect, a method, comprising: detecting a surface within a real-world area, the surface being captured by a user via an image sensor in a mobile device; receiving an AR generation instruction to generate an AR anchor corresponding with an AR generation area intersecting the surface within the real-world area; and modifying a capture instruction, in response to the AR generation instruction, and based on the intersection of the AR generation area with the surface. The modifying the capture instructions may define a capture arc. Also, the capture instruction may be displayed within an adaptive AR placement user interface. Further, the capture instruction may include a capture progress bar.

In another aspect, a method, comprising: detecting a surface within a real-world area, the surface being associated with an obstacle captured by a user via an image sensor in a mobile device; receiving an AR generation instruction to generate an AR anchor at a target location; and modifying an AR placement user interface based on an AR generation area around the target location intersecting the surface. The method may further comprise defining a capture instruction displayed via the AR placement user interface based on the AR generation area around the target location. Also, the method may further comprises defining the AR generation area such that the AR generation area does not intersect the surface.

The aspects of the methods according to the invention described above may of course also be used as aspects of corresponding apparatuses.

In an aspect an apparatus, comprising: a sensor system configured to capture at least a portion of a real-world area using a mobile device; a surface identification engine configured to detect a surface within the real-world area; an anchor generation engine configured to receive an AR generation instruction to generate an AR anchor at a target location within a threshold distance of the surface within the real-world area; and an adaptive AR placement user interface configured to define a capture instruction, in response to the AR generation instruction and based on the target location being within the threshold distance. The capture instruction may be modified from a default capture instruction define to scan entirely around the target location. Also, the capture instruction may include a capture arc less than 360 degrees.

In another aspect an apparatus, comprising: a sensor system configured to capture at least a portion of a real-world area using a mobile device; a surface identification engine configured to detect a surface within the real-world area via an image sensor in the mobile device; an anchor generation engine configured to receive an AR generation instruction to generate an AR anchor intersecting the surface within the real-world area, the AR anchor being at a target location for display of an AR object; and an adaptive AR placement user interface configured to define a capture instruction, in response to the AR generation instruction and based on the intersection.

### BRIEF DESCRIPTION OF THE DRAWINGS

FIG. 1 is a diagram of a user within a physical area viewing an augmented reality (AR) object associated with an AR anchor.

FIG. 2 is a block diagram illustrating a system configured to implement the concepts described herein.

FIGS. 3A through 3C illustrates user-interface views of an adaptive AR placement user interface implementing at least some portions of the processes described above based on the presence or absence of various obstacles.

FIGS. 4A through 4C illustrates another example of an adaptive AR placement UI.

FIGS. 5A through 5C illustrates another example of instructions displayed within an adaptive AR placement UI.

FIGS. 5D and 5E illustrates additional examples of instructions displayed within an adaptive AR placement UI.

FIG. 6 illustrates AR anchor generation based on a distance.

FIG. 7 illustrates an example of AR anchor localization.

FIGS. 8A and 8B illustrates a real-world scene without and with an AR object, respectively.

FIGS. 9 through 12 illustrate methods of generating an AR anchor as described herein.

FIG. 13 shows an example of a generic computer device and a generic mobile computer device.

### DETAILED DESCRIPTION

Placing an augmented reality (AR) object in the proper location and/or orientation within an image of a real-world scene viewed through a mobile device of a user can be difficult to achieve. An AR object may not be associated (e.g., anchored) with a physical location when physical obstacles make it difficult to create an AR anchor within the physical location for the AR object. For example, a wall or other object may prevent scanning of an area (e.g., a 360 degree scanning arc around a periphery of a physical area) for, or as, an AR anchor so that an AR object can be associated with the AR anchor. Accordingly, an AR anchor may not be created in a desirable fashion, when obstacles are present, so that the AR object can be later viewed by the user placing the AR object or by others intending to interact with the AR object. In some implementations, the AR anchor can include a mapping of a physical area around a target location for the AR object and/or a real-world area C1 coordinate system location for localization (e.g., a global positioning system (GPS) location). The target location can be an approximately or target area for place of the AR anchor and AR object associated with the AR anchor.

The AR anchor can ensure that an AR object (associated with the AR anchor) stays at the same position and orientation in space, helping maintain the illusion of virtual objects placed in the real world. The AR anchor allows devices to recognize and resolve a space, so a user can share the AR experience with others simultaneously and/or return to the same AR experience later (e.g., provide persistence). The AR anchor (and associated AR object) can be created by one user (or device) and resolved by the same user (or device) at a later time, or another user at a later time. In some implementations, persistent AR anchors that can be saved for use by one or more users can be a type of AR cloud anchor.

To achieve accurate placement of AR objects (also can be referred to as points of interest (POIs)) at an AR anchor, an adaptive AR placement user interface (UI) can be used to generate (e.g., create) an AR anchor. The adaptive AR placement UI can adapt an AR anchor generation algorithm to obstacles within the physical environment so that an AR anchor can be generated in a desirable fashion. For example, the adaptive AR placement UI can trigger (e.g., allow for) scanning of a portion of a physical area (e.g., less than 360 area) as an AR anchor. When the AR anchor is generated, the AR object can be displayed in proper context at the AR anchor within the real world using augmented reality. In some implementations, the AR object, when rendered appears anchored to the physical element. In some implementations, a target area is detected and a range (e.g., area and/or angle range) for AR anchor generation (e.g., a progress ring) can be adapted into an environment of a user to facilitate proper AR anchor generation.

In some implementations, for example, GPS and Wi-Fi can be used, at least in part, to localize the device to an AR anchor. In some implementations, a magnetometer sensor can be used, at least in part, to orient the device's direction (e.g., the magnetometer sensor may be relatively inaccurate, and/or may be impaired by local magnetic fields) relative to an AR anchor.

Although the concepts described herein are generally discussed with respect to AR anchor generation, the concepts described herein can be applied to any type of scanning. For example, an adaptive UI, as described herein, can be applied to any type of three-dimensional (3D) scanning such as a 3D volumetric scan. Specifically, the adaptive UI described herein can be used to guide a user during 3D scanning of an object using a mobile device.

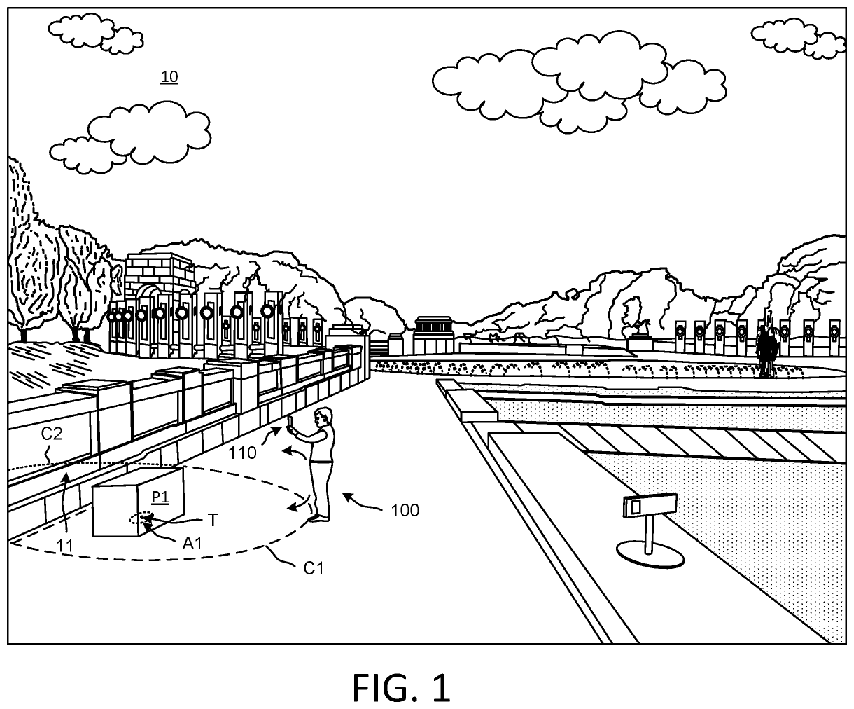

FIG. 1 is a diagram of a user 100 within a real-world area 10 (e.g., a real-world venue) viewing an AR object P1 through a mobile device 110. The location (e.g., location and/or orientation, and/or distance and orientation) of the user 100 is localized against the real-world area 10. The AR object P1 has a fixed location within the real-world area 10 as within an AR anchor A1 (represented in FIG. 1 as a dashed circle).

The AR object P1 is displayed properly within (e.g., on a display screen of) the mobile device 110 utilizing a combination of localization of the mobile device 110 of the user 100 (can be referred to as localization of the user 100 and/or localization of the mobile device 110) to the real-world area 10, and the fixed location of the AR object P1 within the real-world area 10 via the AR anchor A1. The AR object P1 can also be included (at fixed locations and orientations (e.g., X, Y, and Z coordinate orientations)) at the AR anchor A1 of the real-world area 10, when the mobile device 110 is localized to the AR anchor A1.

For example, in some implementations, a representation of a real-world scene from the real-world area 10 can be captured by the user 100 using a camera of the mobile device 110. The real-world scene can be a portion of the real-world area 10 captured by a camera (e.g., the camera of the mobile device 110). A location (and/or orientation) of the mobile device 110 can be associated with the AR anchor A1 based on a comparison (e.g., matching of features) of the representation of the real-world scene with a portion of the AR anchor A1 and/or a location (e.g., GPS location). In some implementations, localizing can include determining the location and orientation of the mobile device 110 with respect to the AR anchor A1. In some implementations, the location and orientation can include a distance from the AR anchor A1 and direction the mobile device 110 is facing with respect to the AR anchor A1. Because the AR anchor A1 has a fixed location with respect to the real-world area 10, the location and orientation of the mobile device 110 with respect to the real-world area 10 can be determined. Thus, the location and the orientation of the mobile device 110 with respect to the AR object P1 can be determined by way of the AR object P1 having a fixed location and orientation within the AR anchor A1 of the real-world area 10. The AR object P1 can then be displayed, at the proper location and orientation, within the mobile device 110 to the user 100. Changes in the location and orientation of the mobile device 110 can be determined through sensors (e.g., inertial measurement units (IMU's), cameras, etc.) and can be used to update locations and/or orientations of the AR object P1 (and/or other AR objects).

When the user 100 creates the AR anchor A1, the user 100 can be prompted to scan an area within the real-world area 10 (e.g., real-world physical area) at a target location (represented as point T in FIG. 1) for the AR anchor A1 (and/or AR object P1). The target location T can be the approximate location for placement of the AR object P1 associated with the AR anchor A1. Accordingly, the AR object P1 and/or AR anchor A1 can both be associated with or approximately centered about the target location T.

The scanning of the AR anchor A1 can be performed within (e.g., performed around) the AR anchor generation area C1. In some implementations, the scanning can be performed around the periphery of the AR anchor generation area C1. The user 100 can move around the periphery of the AR anchor generation area C1 (as illustrated by arrows), while aiming a camera of the mobile device 110 toward the target location T of the AR object P1. The AR anchor A1 can be an image and/or a representation associated with the target location T (e.g., point and/or an area) within the real-world area 10 that can be used to later identify the location for rendering of the AR object P1.

Although referred to as an AR anchor generation area, the AR anchor generation area can be, or can correspond with a volume, a location, a set of locations, a pattern, a path (e.g., an arc path), and/or so forth. In some implementations, an AR anchor generation area can correspond with an area that is scanned to define an AR anchor.

Because a target AR anchor generation area (including both area C1 and C2) intersects (e.g., is adjacent to, includes) a surface 11 (e.g., an obstacle, an object) within the real-world area 10, generation of the AR anchor A1 is adapted in this example (e.g., modified) to accommodate the surface 11. The target AR anchor generation area, which includes both C1 and C2 can be an area calculated for desirable capture the AR anchor A1 (at target location T) and placement of the AR object P1. The target AR anchor generation area can be an area centered around the target location T for placement of the AR object P1. The target AR anchor generation area can be a default circular AR anchor generation area around the target location T. In some implementations, the AR anchor generation area C1 can be derived from the target AR anchor generation area based on the presence of the surface 11.

In some implementations, the adapting of the generation of the AR anchor A1 can include adapting an instruction to generate the AR anchor A1 around AR anchor generation area C1. In some implementations, the instruction to generate the AR anchor A1 can be presented on a user interface of the mobile device 110. In some implementations, the AR anchor generation area C1 can correspond with an area scanned as part of the AR anchor A1. In some implementations, AR generation can be adapted if the AR anchor generation area C1, if a complete circle (with area C1 and C2), would intersect the surface 11. Without adapting the AR anchor generation area C1 to exclude an arc (associated with area C2) through the surface 11, an AR generation area (e.g., a default AT generation area) could include area C2, which would go through the surface 11 and would be an impossible area (e.g., path) for the user 100 to use for AR anchor generation.

As an example, the AR anchor generation area C1 can be defined so that scanning of the AR anchor A1 is performed along a semi-circular shape (or arc) as shown in FIG. 1 instead of around the entirety (e.g., 360 degrees, areas C1 and C2) of the target location T of the AR anchor A1. Because of the surface 11, scanning around the entirely of the target location T of the AR anchor A1 would be difficult or impossible. In some implementations, a user interface used to direct the user 100 to generate the AR anchor A1 can be adapted based on the surface 11. In some implementations, the generation of the AR anchor A1 can be adapted based on the presence of multiple surfaces (e.g., obstacles) detected within the real-world area 10. In some implementations, the AR anchor generation area C1 can be defined so AR anchor generation area C1 does not intersect the surface 11 or other surfaces (e.g., obstacles).

In some implementations, a scan area associated with AR anchor generation can be decreased so that a more complete scan of an AR anchor can be completed. For example, in some implementations, the radius of the AR anchor generation area C1 can be decreased (in response to detection of the surface 11) so that a more complete scan arc (e.g., greater than 180 degrees, 270 degrees) around the AR anchor A1 (and AR object P1) for creation of the AR anchor A1 can be achieved.

In some implementations, a scan area associated with AR anchor generation can be changed based on the size of a target AR object. For example, in some implementations, the radius of an AR anchor generation area can be decreased, despite detection of an obstacle, so that a more complete scan arc (e.g., greater than 180 degrees, 270 degrees) around an AR anchor (and AR object) can be achieved when the AR object is relatively small. In such instances, the AR object may be small enough that a relatively complete scan for placement of the AR object at the AR anchor can be achieved even though the target location of the AR object is near an obstacle. As another example, if the AR object is relatively large and near an obstacle, the radius of the AR anchor generation area may be relatively large and the scan arc may need to be decreased accordingly.

In some implementations, AR anchor generation can be adapted based on at least a portion of the AR anchor A1 having at least a portion of an area intersecting (e.g., being adjacent to (e.g., within a threshold distance), including) at least a portion of a surface such as surface 11. In some implementations, AR anchor generation can be adapted based on at least a portion (e.g., an area) of the AR anchor A1 that is scanned during AR anchor generation intersects (e.g., is adjacent to (e.g., within a threshold distance), includes) at least a portion of a surface such as surface 11. In some implementations, AR anchor generation can be adapted based on a target location T of the AR object P1 intersecting at least a portion of a surface such as surface 11.

In some implementations, the AR anchor generation can be adapted based on a condition associated with the surface 11 being satisfied. For example, in some implementations, the AR anchor generation can be adapted based on a size (e.g., a volume, a surface area) of the surface 11. In some implementations, the AR anchor generation can be adapted based on a threshold size of the surface 11 being exceeded.

As a specific example, if the surface 11 is large enough (beyond a threshold size) to disrupt AR anchor generation, the AR anchor generation (e.g., an instruction or guide for triggering AR anchor generation) can be adapted. As a specific example, if the surface 11 has a size that is large enough that the AR generation area C1 cannot be a full circle (e.g., a full circle includes areas C1 and C2). If the surface 11 was shorter (e.g., such that the user 100 could climb over the surface during AR anchor generation) AR anchor generation may not be adapted.

In some implementations, the AR anchor generation may not be adapted based on a condition associated with the surface 11 being unsatisfied. For example, in some implementations, the AR anchor generation may not be adapted based on a size (e.g., a volume, a surface area) of the surface 11. In some implementations, the AR anchor generation may not be adapted based on a size of the surface 11 falling below a threshold size. As another example, if an obstacle is an overhanging area that a user could move below, AR generation may not be adapted.

As a specific example, if the surface 11 was shorter than shown in FIG. 1, the user 100 could climb over the surface 11 during AR anchor generation. In such instances, the AR anchor generation may not be adapted and a full 360 degree scan (or a larger scan arc) of the target location T (e.g., around a periphery or area around the target location T) of the AR anchor A1 can be scanned for generation of the AR anchor A1 and placement of the AR object P1.

In some implementations, a location can include a location in X, Y, Z coordinates, and an orientation can include a directional orientation (e.g., direction(s) or angle(s) that an object or user is facing, a yawl, pitch, and roll). Accordingly, a user (e.g., user 100) and/or an AR object (e.g., AR object P1) can be at a particular X, Y, Z location and facing in particular direction as an orientation at that X, Y, Z location.

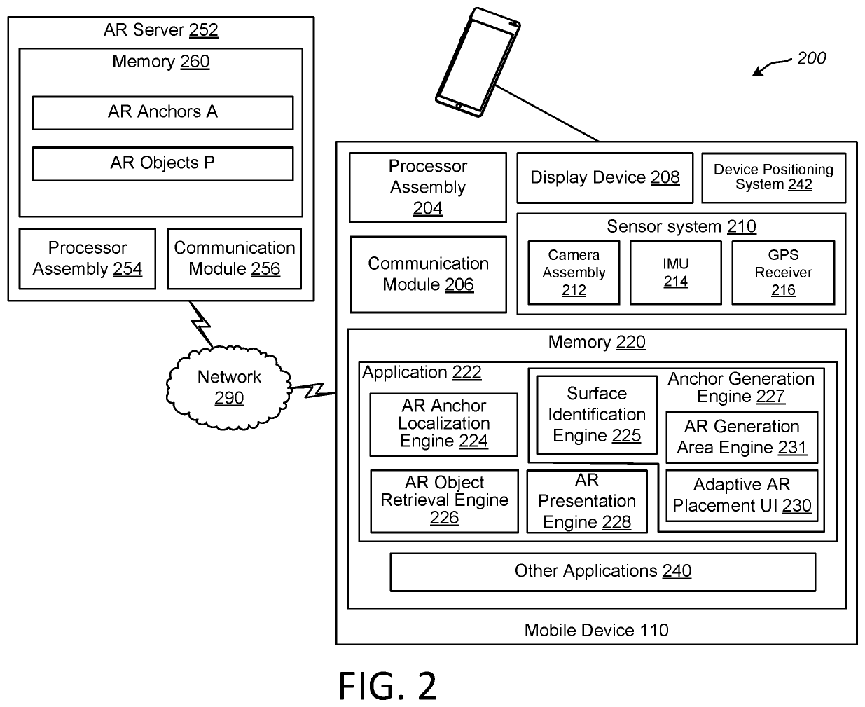

FIG. 2 is a block diagram illustrating a system 200 configured to implement the concepts described herein (e.g., the generic example shown in FIG. 1), according to an example implementation. The system 200 includes the mobile device 110 and an AR server 252. FIG. 2 illustrates details of the mobile device 110 and the AR server 252. Using the system 200, one or more AR objects can be displayed within a display device 208 of the mobile device 110 utilizing a combination of localization of the mobile device 110 to an AR anchor within a real-world area, and a fixed location and orientation of the AR object within the real-world area. The operations of the system 200 will be described in the context of FIG. 1 and other of the figures.

The mobile device 110 may include a processor assembly 204, a communication module 206, a sensor system 210, and a memory 220. The sensor system 210 may include various sensors, such as a camera assembly 212, an inertial motion unit (IMU) 214, and a global positioning system (GPS) receiver 216. Implementations of the sensor system 210 may also include other sensors, including, for example, a light sensor, an audio sensor, an image sensor, a distance and/or proximity sensor, a contact sensor such as a capacitive sensor, a timer, and/or other sensors and/or different combinations of sensors. The mobile device 110 includes a device positioning system 242 that can utilize one or more portions of the sensor system 210.

The mobile device 110 also includes the display device 208 and the memory 220. An application 222 and other applications 240 are stored in and can be accessed from the memory 220. The application 222 includes an AR anchor localization engine 224, an AR object retrieval engine 226, an AR presentation engine 228, and an anchor generation engine 227. The anchor generation engine 227 includes a surface identification engine 225, an AR generation area engine 231, and an adaptive AR UI engine 230. In some implementations, the mobile device 110 is a mobile device such as a smartphone, a tablet, a head-mounted display device (HMD), glasses that are AR enabled, and/or so forth.

The system illustrates details of the AR server 252, which includes a memory 260, a processor assembly 254 and a communication module 256. The memory 260 is configured to store AR anchors A (which can include the AR anchor A1 from FIG. 1), and AR objects P (and can include the AR object P1 from FIG. 1).

Although the processing blocks shown in AR server 252 and the mobile device 110 are illustrated as being included in a particular device, the processing blocks (and processing associated therewith) can be included in different devices, divided between devices, and/or so forth. For example, at least a portion of the surface identification engine 225 can be included in the AR server 252.

The anchor generation engine 227 is configured to be used by a user (e.g., user 100 shown in FIG. 1) when creating an AR anchor (e.g., AR anchor A1) associated with or for placement of an AR object (e.g., AR object P1 shown in FIG. 1). A user 100 can identify that the AR object P1 is to be placed at the target location T. The anchor generation engine 227 can then be used to place the AR object P1 by generating an AR anchor A1 associated with the AR object P1. Accordingly, the AR anchor A1 can be placed, using the anchor generation engine 227 at the target location T within the real-world area 10.

In the process of creating the AR anchor A1, the sensor system 210 can be configured to capture at least a portion of real-world area 10 using the mobile device 110. Specifically, the sensor system 210 can be triggered to capture at least the portion of the real-world area 10 by the anchor generation engine 227.

In order to generate the AR anchor A1, an AR generation area C1 can be defined around the target location T by the AR generation area engine 231. The surface identification engine 225 can be configured to identify the surface 11 (and/or other surfaces that can be associated with one or more objects or obstacles) that intersects (e.g., are adjacent to) the AR generation area C1 defined by the AR generation area engine 231. The AR generation area C1 can be defined by the AR generation area engine 231, and a user interface used to instruct generation of the AR anchor A1 within the AR generation area C1 can be adapted to the defined AR generation area C1. Specifically, the scan area corresponding with the AR generation area C1 is defined as approximately a semi-circle (e.g., a semicircular arc) by the AR generation area engine 231 because of the presence of the surface 11 and the instruction (e.g., guide) generated by the adaptive AR UI engine 230 within an adaptive AR placement UI (not shown) can be adapted to match the semi-circular shape of the AR generation area C1.

Said differently, the anchor generation engine 227 can be configured to modify AR anchor generation in response to obstacles that are detected by the surface identification engine 225. An AR user interface can be adapted by the adaptive AR placement UI 230 based on the obstacles to direct the user 100 to generate the AR anchor A1. In some implementations, the AR user interface can be adapted by the adaptive AR placement UI 230 based on the obstacles to direct the user 100 to generate the AR anchor A1 based on the AR generation area determined by the AR generation area engine 231 based on the obstacles.

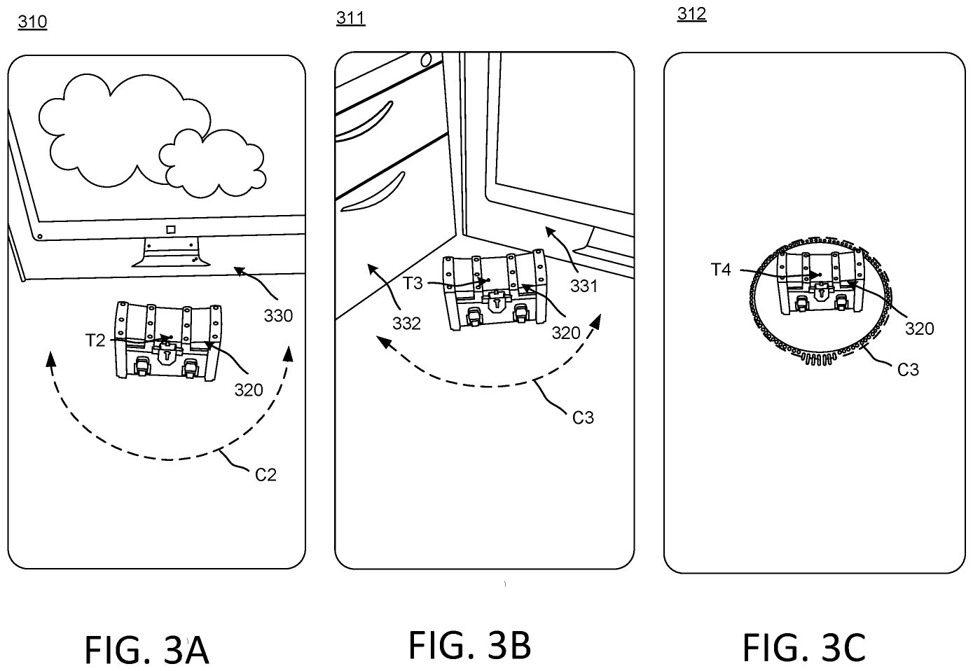

FIGS. 3A through 3C illustrates user-interface views of an adaptive AR placement UI implementing at least some portions of the processes described above based on the presence or absence of various obstacles. FIG. 3A illustrates a user-interface view of an adaptive AR placement UI 310 implementing the process described above. As shown in FIG. 3A, a user is instructed to scan an area (e.g., an arc) approximately 180 degrees (represented by dashed arrow C2) around an AR object 320 to create an AR anchor associated with a target location T2 based on the presence of an obstacle 330 (e.g., a vertical wall).

FIG. 3B illustrates a user-interface view of an adaptive AR placement UI 311 implementing the process described above. As shown in FIG. 3B, a user is instructed to scan an area (e.g., an arc) less than 180 degrees around the AR object 320 to create an AR anchor associated with a target location T3 based on the presence of two obstacles 331, 332 (e.g., vertical walls).

FIG. 3C illustrates a user-interface view of an adaptive AR placement UI 312 implementing the process described above. As shown in FIG. 3C, a user is instructed to scan an area around an entirety (e.g., 360 degrees) around the AR object 320 to create an AR anchor associated with a target location T4 based on the absence of obstacles (e.g., no identified surfaces that interfere with AR anchor generation). In some implementations, the scan around an entirety of an AR object can be referred to as a default anchor generation mode or scan.

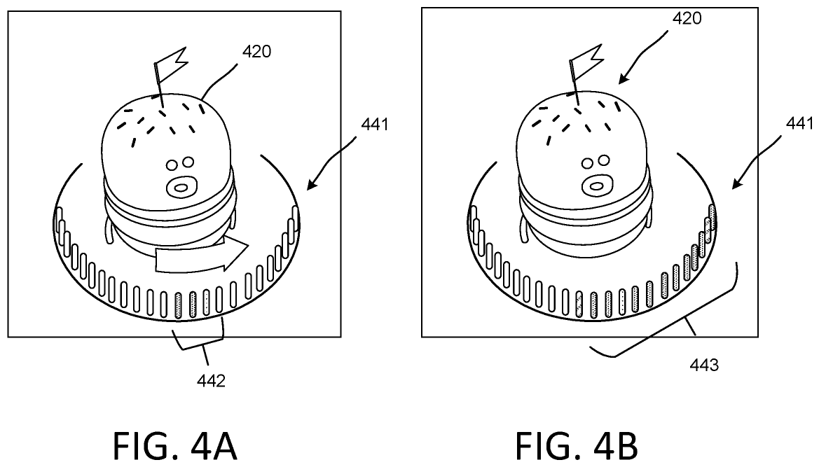

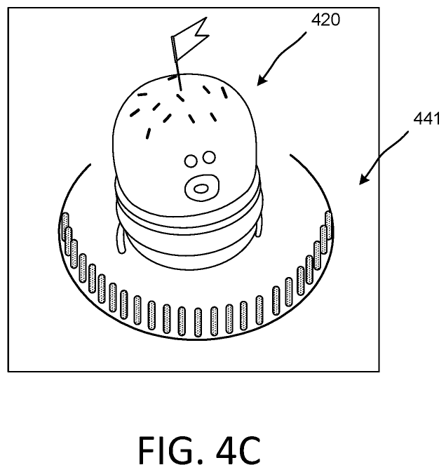

Another example of an adaptive AR placement UI 410 is shown in FIGS. 4A through 4C. As shown in FIG. 4A, a user can be directed by an arrow to scan around an AR object 420. Elements 442 (e.g., shown as small vertically oriented oval elements) (also can be referred to as portions, segments, or sections) included in a progress bar 441 are colored with various colors as scanning progresses. As shown in FIG. 4B, more of the elements 443 of the progress bar 441 are colored with various colors as the scanning progresses. As shown in FIG. 4C, scanning is completed and all of the elements of the progress bar 441 are colored with colors that indicate that scanning is completed. After the scanning is completed, the AR anchor for the AR object 420 can be stored.

In some implementations the colors of the elements of the progress bar 441 can indicate different instructions or information. White elements can indicate (or correspond with) an area that has not yet been scanned. Orange and yellow elements can indicate (or correspond with) areas that have been scanned with low and medium quality, respectively. Green elements can indicate (or correspond with) areas that have been scanned at high quality.

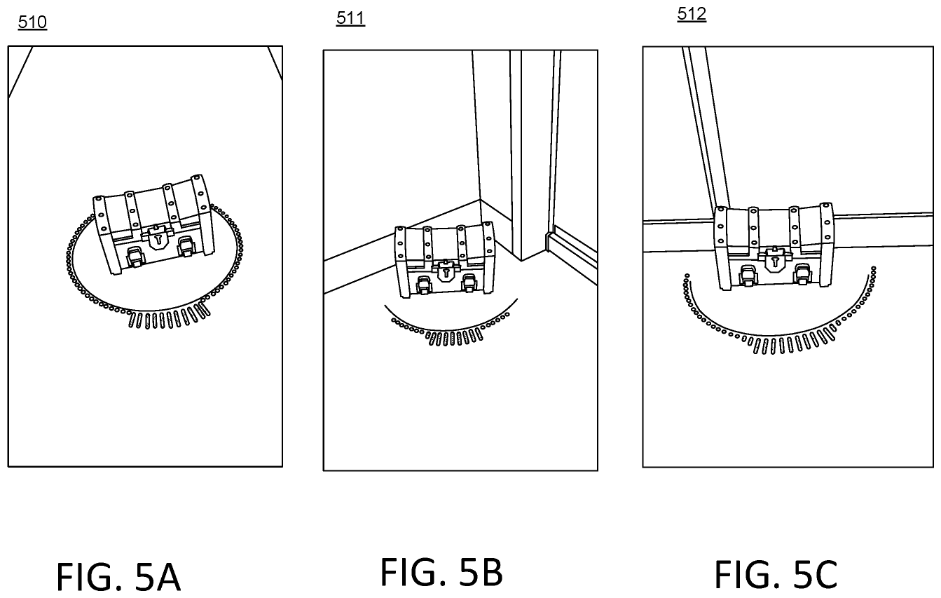

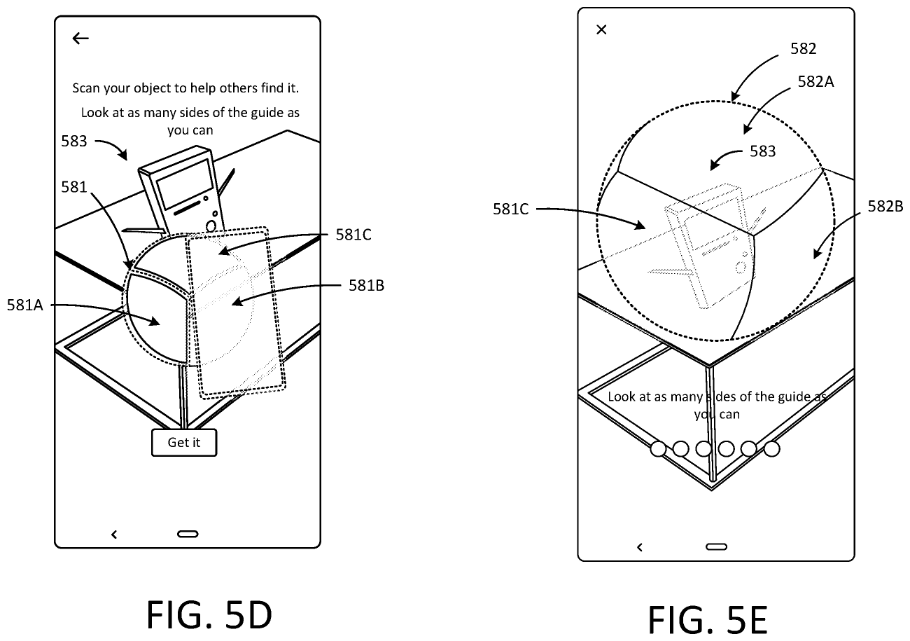

Referring back to FIG. 2 and as mentioned above, in some implementations, the adapting of the generation of an AR anchor can include adapting an instruction (e.g., guide) within an adaptive AR placement UI to generate the AR anchor. In some implementations, the instruction to generate the AR anchor A1 can be presented by the adaptive AR UI engine 230 within the adaptive AR placement UI of the mobile device 110. A few such examples are shown in FIGS. 5A through 5C.

FIG. 5A illustrates a progress ring within an adaptive AR placement UI 510 during AR anchor generation that sets a default progress ring with a range of 360 degrees based on the absence of obstacles. FIG. 5B illustrates a progress ring with a range of approximately 90 degrees within an adaptive AR placement UI 511 AR anchor generation based on the presence of two obstacles. FIG. 5C illustrates a progress ring with a range of approximately 180 degrees within an adaptive AR placement UI 512 AR anchor generation based on the presence of one obstacle (e.g., one vertical wall). The progress rings can guide the user to move in a particular direction.

FIGS. 5D and 5E illustrate additional UI implementations that can be used in connection with the concepts described herein. In some implementations, rather using a progress ring, the UI can include a progress sphere 581 such as shown in FIG. 5D and a progress sphere 582 such as shown FIG. 5E. The progress spheres 581 and 582 are targeted to an AR object 583. The size and/or shape of the progress sphere can be adapted based on one or more obstacles. For example, a progress sphere around an object can be the default shape for scanning around an object. If there is an obstacle that would intersect the progress sphere, the progress sphere can be truncated into a portion (e.g., an element, a segment, a section) of a progress sphere (e.g., truncated into a hemisphere). In these implementations, portions of the progress spheres are labeled as 581A-C (FIG. 5D) and 582A-C (FIG. 5E). Other shapes and/or UI can be implemented in connection with the concepts described herein including square shapes, oval shapes, elliptical shapes, and/or so forth. In some implementations, the progress UI can have an irregular shape that is non-uniform and/or asymmetrical.

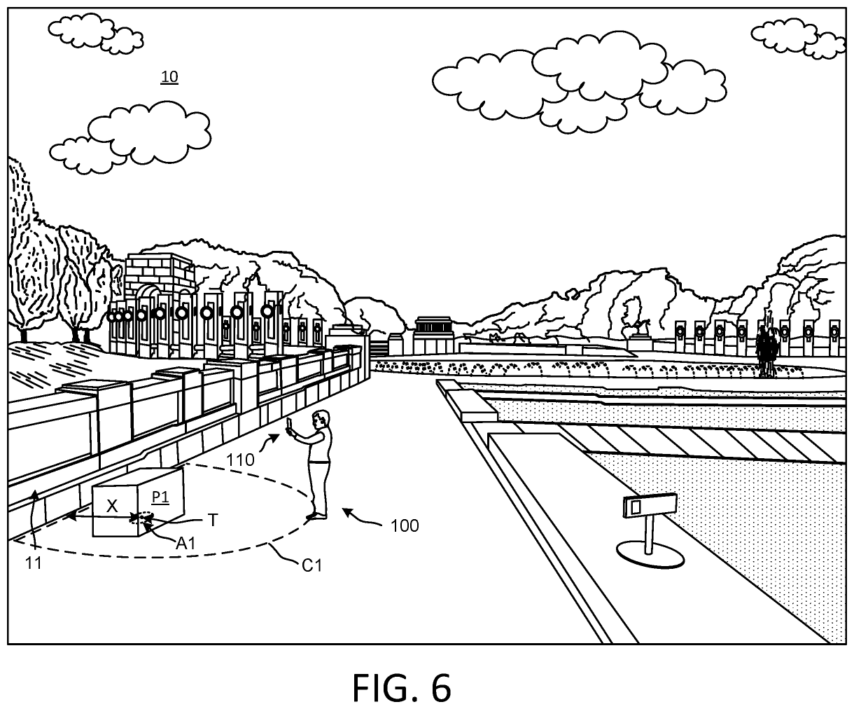

As shown in FIG. 6, in some implementations, AR anchor generation can be adapted based on a distance X. In some implementations, the distance X can be a distance between the target location T and the surface 11. In some implementations, the distance X can be a distance between the target location T and a portion (e.g., a centroid, middle portion) of the AR object P1. For example, if the distance X between the target location T and the surface 11 satisfies a condition (e.g., is within a threshold distance), the AR anchor generation can be adapted (e.g., a length (or degrees) of a scan arc can be defined). In some implementations, AR anchor generation can be adapted if a distance (e.g., a minimum distance) between an edge of the AR object P1 and the surface 11 satisfies a threshold condition (e.g., is within a threshold distance).

The AR anchors A (which can each be unique) can each be at fixed locations (and/or orientations) within a coordinate space of the real-world area 10. In some implementations, at a minimum each of the AR anchors P have a location (without an orientation) within the real-world area 10.

As mentioned above, the AR anchors A can be used to localize a user 100 (e.g., a mobile device 110 of the user) to the real-world area 10. In some implementations, the AR anchors can be considered AR activation markers. The AR anchors A can be generated so that the mobile device 110 of the user can be localized to one or more of the AR anchors A. For example, the AR anchors A can be an image and/or a representation associated with a location (e.g., point and/or an area) with the real-world area 10. In some implementations, the AR anchors A (like the real-world area 10) can be a collection of points (e.g., a point cloud) that represent features (e.g., edges, densities, buildings, walls, signage, planes, objects, textures, etc.) at or near a location (e.g., point and/or an area) within the real-world area 10. In some implementations, the AR anchors A can be a spherical image (e.g., color image) or panorama associated with a location within the real-world area 10. In some implementations, one or more of the AR anchors A can be an item of content. In some implementations, the AR anchors A can be one or more features associated with a location within the real-world area 10.

In some implementations, one or more of the AR anchors A can be created by capturing a feature (e.g., an image or a set of images (e.g., a video), a panorama, a scan) while the user 100 (holding mobile device 110) physically stands at or moves around a point (e.g., a target location) and/or an area within a real-world area 10. The creation of the AR anchors A can be performed using the anchor generation engine 227. The captured feature(s) can then be mapped to a location (e.g., collection of features associated with a location) within the real-world area 10 as an AR anchor A1 shown in FIG. 1. This information can be stored in the AR server 252.

In some implementations, one or more of the AR anchors A within the real-world area 10 can include uniquely identifiable signs (e.g., physical signs) which will be used as AR activation markers. In some limitations, the signs can include text, QR, custom-designed visual scan codes, and/or so forth. In some implementations, the AR anchors A can be uniquely identifiable physical signs that are connected by location and/or orientation within, for example, the real-world area 10. The physical signage in a real-world area 10 can be used to precisely calibrate the location and/or orientation of the mobile device 110.

The AR anchor localization engine 224 in FIG. 2 can be configured to determine a location of the mobile device 110 based on a comparison (e.g., matching of features) of a representation of a real-world scene with a portion of the real-world area 10 of the real-world area. The comparison can include comparison of features (e.g., edges, densities, buildings, walls, signage, planes, objects, textures, etc.) captured through the mobile device 110 with features included in or represented within, for example, the real-world area 10. In some implementations, the comparison can include comparison of portions of an image captured through the mobile device 110 with portions of an image associated with the real-world area 10.

The camera assembly 212 can be used to capture images or videos of the physical space such as a real-world scene from the real-world area 10 around the mobile device 110 (and user 100) for localization purposes. The camera assembly 212 may include one or more cameras. The camera assembly 212 may also include an infrared camera. In some implementations, a representation (e.g., an image) of a real-world scene from the real-world area 10 can be captured by the user 100 using the camera assembly 212 camera of the mobile device 110. The representation of the real-world scene can be a portion of the real-world area 10. In some implementations, features (e.g., image(s)) captured with the camera assembly 212 may be used to localize the mobile device 110 to one of the AR anchors A stored in the memory 260 of the AR server 252.

Based on the comparison of features, the AR anchor localization engine 224 can be configured to determine the location and/or orientation of the mobile device 110 with respect to one or more of AR anchors A. The location (and/or orientation) of the mobile device 110 can be localized against the location of one of the AR anchors A through a comparison of an image as viewed through the mobile device 110. Specifically, for example, an image captured by a camera of the mobile device 110 can be used to determine a location and orientation of the mobile device 110 with respect to the AR anchors A.

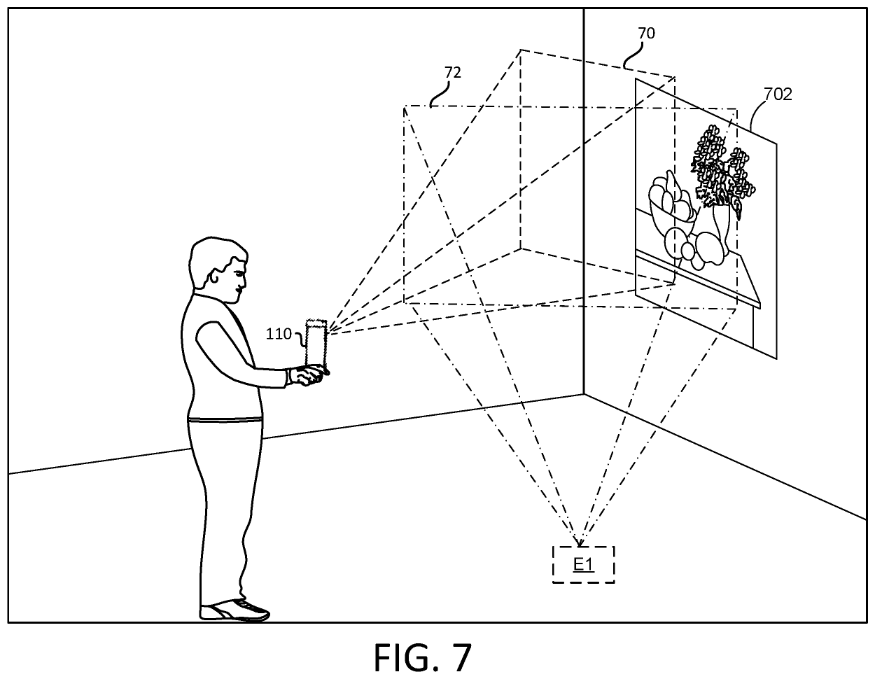

Another example of localization is illustrated in FIG. 7 where the mobile device 110 captures a portion of a corner of a wall and a part of a painting 702 (e.g., inside of a building, inside of a building on a particular floor (e.g., of a plurality of floors) of the building). The captured area is shown as captured area 70. This captured area 70 can be used to localize the mobile device 110 to the AR anchor E1, which was previously captured (e.g., captured by another mobile device) from a different angle and includes overlapping area 72 as illustrated by dash-dot lines. Specifically, the features of the captured area 70 can be compared with the features of the overlapping area 72 associated with the AR anchor E1, to localize the mobile device 110 to the AR anchor E1.

In some implementations, the AR anchor localization engine 224 can be configured to determine the location and/or orientation of the mobile device 110 with respect to one of multiple AR anchors A. In some implementations only one of the AR anchors A is selected for localization when the user is at a specified location (or area) at a given time (or over a time window).

Even after localizing at one of the AR anchors A, the precise location and orientation of the mobile device 110 within the physical real-world may not be known. Only the relative location and orientation of the mobile device 110 with respect to at least one of the AR anchors A (and within the real-world area 10 by way of the AR anchor A) is known. The ad-hoc capture of feature (e.g., image) information by the mobile device 110 is used to determine the relative location of the mobile device 110.

In some implementations, images captured with the camera assembly 212 may also be used by the AR anchor localization engine 224 to determine a location and orientation of the mobile device 110 within a physical space, such as an interior space (e.g., an interior space of a building), based on a representation of that physical space that is received from the memory 260 or an external computing device. In some implementations, the representation of a physical space may include visual features of the physical space (e.g., features extracted from images of the physical space). The representation may also include location-determination data associated with those features that can be used by a visual positioning system to determine location and/or position within the physical space based on one or more images of the physical space. The representation may also include a three-dimensional model of at least some structures within the physical space. In some implementations, the representation does not include three-dimensional models of the physical space.

In some implementations, multiple perception signals (from one or more of the sensor systems 210) can be used by the AR anchor localization engine 224 to uniquely identify an AR anchor. In some implementations, these include, but are not limited to: image recognition and tracking, text recognition and tracking, AR tracked oriented points, GPS position, Wifi signals, QR codes, custom designed visual scan codes, and/or so forth.

With reference to FIG. 1, changes in the location and orientation of the mobile device 110 with respect to the AR anchor A1 can be determined through sensors (e.g., inertial measurement units (IMU's), cameras, etc.) and can be used to update locations and/or orientations of the AR object P1. For example, if the mobile device 110 is moved to a different direction, the display of the AR object P1 can be modified within the display device 208 of the mobile device 110 accordingly.

Referring back to FIG. 2, the AR object retrieval engine 226 can be configured to retrieve one or more AR objects P from the AR server 252. For example, the AR object retrieval engine 226 may retrieve AR objects P within the real-world area 10 based on the reconciliation of the coordinate spaces of the AR objects P, the real-world area 10, and the AR anchors A performed by surface identification engine 225.

The AR presentation engine 228 presents or causes one or more AR objects P to be presented on the mobile device 110. For example, the AR presentation engine 228 may cause the adaptive AR placement UI 230 to generate a user interface that includes information or content from the one or more AR objects P to be displayed by the mobile device 110. In some implementations, the AR presentation engine 228 is triggered by the AR object retrieval engine 226 retrieving the one or more AR objects P. The AR presentation engine 228 may then trigger the display device 208 to display content associated with the one or more AR objects P.

The adaptive AR placement UI 230 can be configured to generate user interfaces. The adaptive AR placement UI 230 may also cause the mobile device 110 to display the generated user interfaces. The generated user interfaces may, for example, display information or content from one or more of the AR objects P. In some implementations, the adaptive AR placement UI 230 generates a user interface including multiple user-actuatable controls that are each associated with one or more of the AR objects P. For example, a user may actuate one of the user-actuatable controls (e.g., by touching the control on a touchscreen, clicking on the control using a mouse or another input device, or otherwise actuating the control).

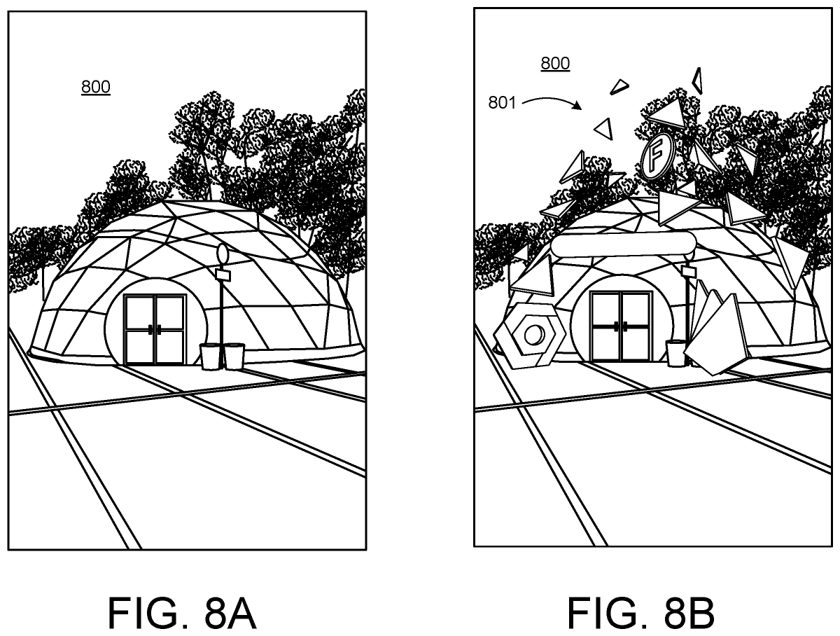

An example of an AR object 801 displayed within a real-world scene 800 is shown in FIG. 8B. The AR object 801 can be stored at an AR server 252. The real-world scene 800 without the AR object 801 is shown in FIG. 8A.

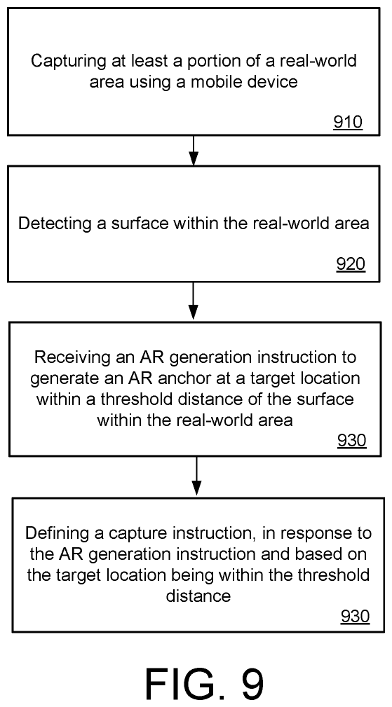

FIGS. 9 through 12 illustrate methods of generating an AR anchor as described herein. The flowchart elements can be performed by at least the anchor generation engine 227 shown in FIG. 2.

As shown in FIG. 9, a method can include capturing at least a portion of a real-world area C2 sing a mobile device (block 910) and detecting a surface (e.g., by the surface identification engine 225 shown in FIG. 2) within the real-world area (block 920). The method can include receiving an AR generation instruction (e.g., at the anchor generation engine 227 shown in FIG. 2) to generate an AR anchor at a target location within a threshold distance of the surface within the real-world area (block 930), and defining a capture instruction (e.g., at the adaptive AR placement UI 230 shown in FIG. 2), in response to the AR generation instruction and based on the target location being within the threshold distance (block 940).

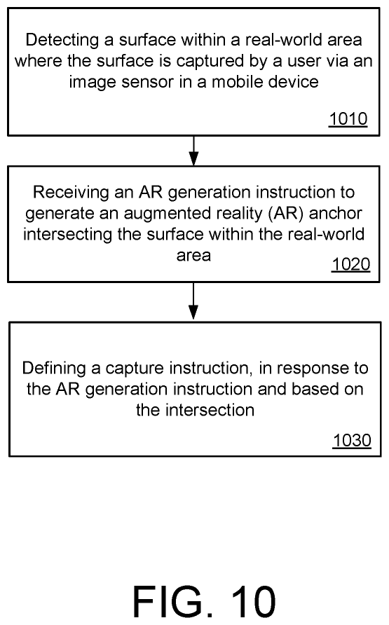

As shown in FIG. 10, the method includes detecting a surface within a real-world area (e.g., by the surface identification engine 225 shown in FIG. 2) where the surface is captured by a user via an image sensor in a mobile device (block 1010) and receiving an AR generation instruction (e.g., at the anchor generation engine 227 shown in FIG. 2) to generate an augmented reality (AR) anchor intersecting the surface within the real-world area (block 1020). The AR anchor can be at a location for display of an AR object. The method also includes defining a capture instruction (e.g., at the adaptive AR placement UI 230 shown in FIG. 2), in response to the AR generation instruction and based on the intersection (block 1030).

In some implementations, the AR anchor intersecting the surface includes an AR generation area (e.g., determined by the AR generation area engine 231 shown in FIG. 2) associated with the AR anchor intersecting the surface. The AR generation area C1 can include a capture path to capture the AR anchor. The defined capture instruction defines the AR generation area. In some implementations, the defining the capture instruction includes modifying the capture instruction from a default capture instruction. The capture instruction can include a capture arc. The capture arc can be less than 360 degrees. In some implementations, the capture instruction is displayed within an adaptive AR placement user interface.

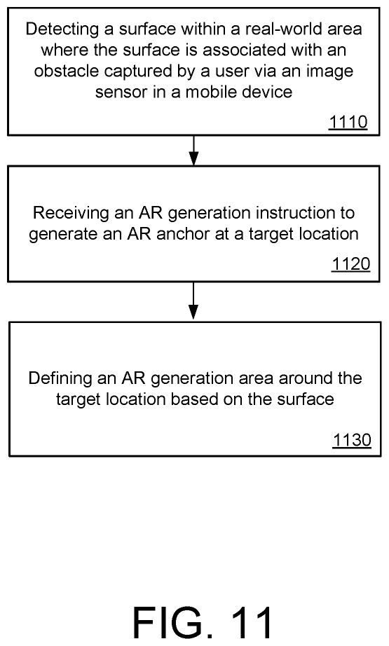

As shown in FIG. 11, a method can include detecting a surface (e.g., by the surface identification engine 225 shown in FIG. 2) within a real-world area where the surface is associated with an obstacle captured by a user via an image sensor in a mobile device (block 1110) and receiving an AR generation instruction (e.g., at the anchor generation engine 227 shown in FIG. 2) to generate an AR anchor at a target location (block 1120). The method can include defining an AR generation area around the target location based on the surface (block 1130). In some implementations, the method can include defining a capture instruction displayed (e.g., at the adaptive AR placement UI 230 shown in FIG. 2) via a user interface based on the AR generation area around the target location. In some implementations, the method can include defining the AR generation area (e.g., at the AR generation area engine 231 shown in FIG. 2) such that the AR generation area does not intersect the surface.

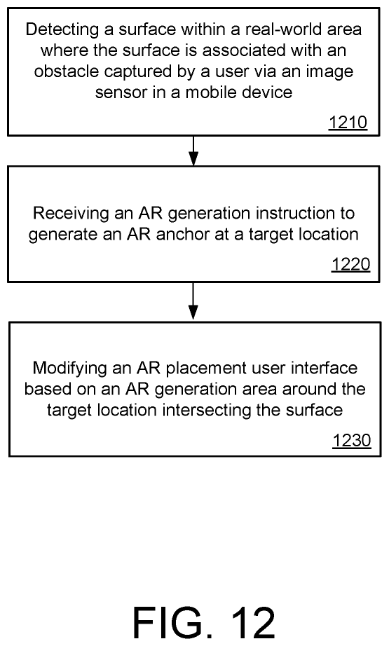

As shown in FIG. 12, a method can include detecting a surface (e.g., by the surface identification engine 225 shown in FIG. 2) within a real-world area where the surface is associated with an obstacle captured by a user via an image sensor in a mobile device (1210), and receiving an AR generation instruction (e.g., at the anchor generation engine 227 shown in FIG. 2) to generate an AR anchor at a target location (1220). The method can include defining an AR generation area (e.g., at the AR generation area engine 231 shown in FIG. 2) around the target location based on the surface (1230).

Referring back to FIG. 2, the IMU 214 can be configured to detect motion, movement, and/or acceleration of the mobile device 110. The IMU 214 may include various different types of sensors such as, for example, an accelerometer, a gyroscope, a magnetometer, and other such sensors. An orientation of the mobile device 110 may be detected and tracked based on data provided by the IMU 214 or GPS receiver 216.

The GPS receiver 216 may receive signals emitted by GPS satellites. The signals include a time and position of the satellite. Based on receiving signals from several satellites (e.g., at least four), the GPS receiver 216 may determine a global position of the mobile device 110.

The other applications 240 include any other applications that are installed or otherwise available for execution on the mobile device 110. In some implementations, the application 222 may cause one of the other applications 240 to be launched.

The device positioning system 242 determines a position of the mobile device 110. The device positioning system 242 may use the sensor system 210 to determine a location and orientation of the mobile device 110 globally or within a physical space.

The AR anchor localization engine 224 may include a machine learning module that can recognize at least some types of entities within an image. For example, the machine learning module may include a neural network system. Neural networks are computational models used in machine learning and made up of nodes organized in layers with weighted connections. Training a neural network uses training examples, each example being an input and a desired output, to determine, over a series of iterative rounds, weight values for the connections between layers that increase the likelihood of the neural network providing the desired output for a given input. During each training round, the weights are adjusted to address incorrect output values. Once trained, the neural network can be used to predict an output based on provided input.

In some implementations, the neural network system includes a convolution neural network (CNN). A convolutional neural network (CNN) is a neural network in which at least one of the layers of the neural network is a convolutional layer. A convolutional layer is a layer in which the values of a layer are calculated based on applying a kernel function to a subset of the values of a previous layer. Training the neural network may involve adjusting weights of the kernel function based on the training examples. Typically, the same kernel function is used to calculate each value in a convolutional layer. Accordingly, there are far fewer weights that must be learned while training a convolutional layer than a fully-connected layer (e.g., a layer in which each value in a layer is a calculated as an independently adjusted weighted combination of each value in the previous layer) in a neural network. Because there are typically fewer weights in the convolutional layer, training and using a convolutional layer may require less memory, processor cycles, and time than would an equivalent fully-connected layer.

The communication module 206 includes one or more devices for communicating with other computing devices, such as the AR server 252. The communication module 206 may communicate via wireless or wired networks, such as the network 290. The communication module 256 of the AR server 252 may be similar to the communication module 206. The network 290 may be the Internet, a local area network (LAN), a wireless local area network (WLAN), and/or any other network.

The display device 208 may, for example, include an LCD (liquid crystal display) screen, an LED (light emitting diode) screen, an OLED (organic light emitting diode) screen, a touchscreen, or any other screen or display for displaying images or information to a user. In some implementations, the display device 208 includes a light projector arranged to project light onto a portion of a user's eye.

The memory 220 can include one or more non-transitory computer-readable storage media. The memory 220 may store instructions and data that are usable by the mobile device 110 to implement the technologies described herein, such as to generate visual-content queries based on captured images, transmit visual-content queries, receive responses to the visual-content queries, and present a digital supplement identified in a response to a visual-content query. The memory 260 of the AR server 252 may be similar to the memory 220 and may store data instructions that are usable to implement the technology of the AR server 252.

The processor assembly 204 and/or processor assembly 254 includes one or more devices that are capable of executing instructions, such as instructions stored by the memory 220, to perform various tasks. For example, one or more of the processor assemblies 204, 254 may include a central processing unit (CPU) and/or a graphics processor unit (GPU). For example, if a GPU is present, some image/video rendering tasks, such as generating and displaying a user interface or displaying portions of a digital supplement may be offloaded from the CPU to the GPU. In some implementations, some image recognition tasks may also be offloaded from the CPU to the GPU.

Although not illustrated in FIG. 2, some implementations include a head-mounted display device (HMD) (e.g., glasses that are AR enabled). The HMD may be a separate device from the mobile device 110 or the mobile device 110 may include the HMD. In some implementations, the mobile device 110 communicates with the HMD via a cable. For example, the mobile device 110 may transmit video signals and/or audio signals to the HMD for display for the user, and the HMD may transmit motion, position, and/or orientation information to the mobile device 110.

The mobile device 110 may also include various user input components (not shown) such as a controller that communicates with the mobile device 110 using a wireless communications protocol. In some implementations, the mobile device 110 may communicate via a wired connection (e.g., a Universal Serial Bus (USB) cable) or via a wireless communication protocol (e.g., any WiFi protocol, any BlueTooth protocol, Zigbee, etc.) with a HMD (not shown). In some implementations, the mobile device 110 is a component of the HMD and may be contained within a housing of the HMD.

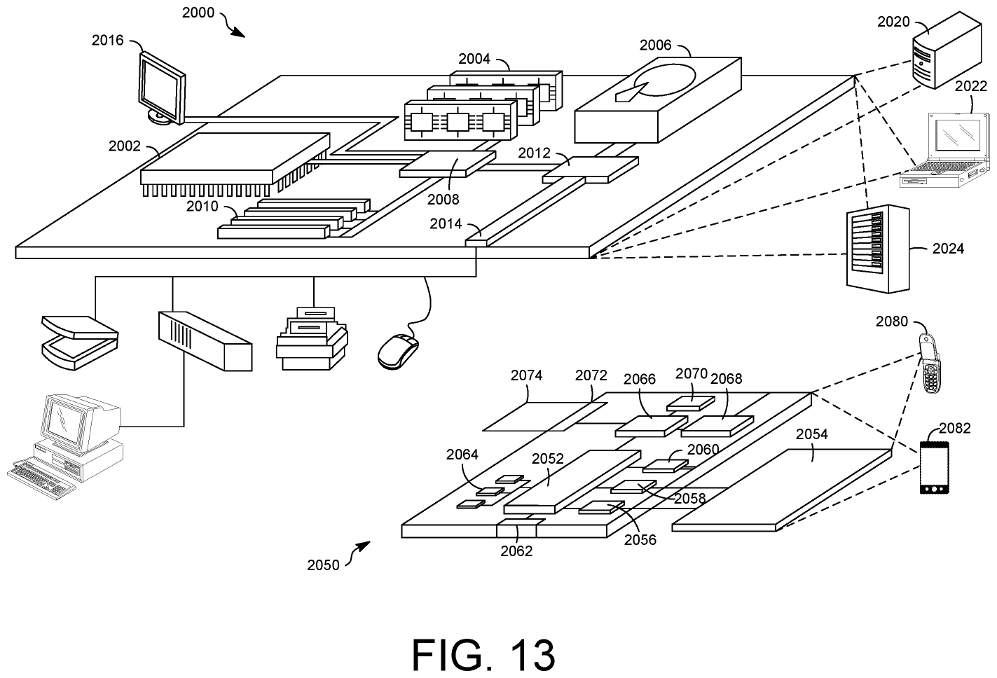

FIG. 13 shows an example of a generic computer device 2000 and a generic mobile computer device 2050, which may be used with the techniques described herein. Computing device 2000 is intended to represent various forms of digital computers, such as laptops, desktops, tablets, workstations, personal digital assistants, televisions, servers, blade servers, mainframes, and other appropriate computing devices. Computing device 2050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 2000 includes a processor 2002, memory 2004, a storage device 2006, a high-speed interface 2008 connecting to memory 2004 and high-speed expansion ports 2010, and a low speed interface 2012 connecting to low speed bus 2014 and storage device 2006. The processor 2002 can be a semiconductor-based processor. The memory 2004 can be a semiconductor-based memory. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high speed interface 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, or memory on processor 2002.

The high speed controller 2008 manages bandwidth-intensive operations for the computing device 2000, while the low speed controller 2012 manages lower bandwidth-intensive operations. Such allocation of functions is exemplary only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low-speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2050, 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (Thin-Film-Transistor Liquid Crystal Display) or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area C1 communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provide as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, or memory on processor 2052, that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, etc.) and may also include sound generated by applications operating on device 2050.

The computing device 2050 may be implemented in a number of different forms, as shown in the figure. For example, it may be implemented as a cellular telephone 2080. It may also be implemented as part of a smart phone 2082, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

1. A method, comprising:
detecting a surface within a real-world area, the surface being captured by a user via an image sensor in a mobile device;
receiving an AR generation instruction to generate an augmented reality (AR) anchor intersecting the surface within the real-world area, the AR anchor being at a target location for display of an AR object; and
defining a capture instruction, in response to the AR generation instruction and based on the intersection.

2. The method of claim 1, wherein the AR anchor intersecting the surface includes an AR generation area associated with the AR anchor intersecting the surface.

3. The method of claim 2, wherein the AR generation area includes a capture path to capture the AR anchor.

4. The method of claim 2, wherein the defined capture instruction defines the AR generation area.

5. The method of claim 1, wherein the defining the capture instruction includes modifying the capture instruction from a default capture instruction.

6. The method of claim 1, wherein the capture instruction includes a capture arc.

7. The method of claim 6, wherein the capture arc is less than 360 degrees.

8. The method of claim 1, wherein the capture instruction is displayed within an adaptive AR placement user interface.

9. The method of claim 1, wherein the surface is a first surface,
the method further comprising:
detecting a second surface within the real-world area, the defining of the capture instruction being based on the first surface and the second surface.

10. The method of claim 9, wherein the capture instruction includes a capture arc less than 180 degrees based on the first surface and the second surface.

11. A method, comprising:
detecting a surface within a real-world area, the surface being captured by a user via an image sensor in a mobile device;
receiving an AR generation instruction to generate an AR anchor corresponding with an AR generation area intersecting the surface within the real-world area; and
modifying a capture instruction, in response to the AR generation instruction, and based on the intersection of the AR generation area with the surface.

12. The method of claim 11, wherein the modifying the capture instructions defining a capture arc.

13. The method of claim 11, wherein the capture instruction is displayed within an adaptive AR placement user interface.

14. The method of claim 11, wherein the capture instruction includes a capture progress bar.

15. A method, comprising:
detecting a surface within a real-world area, the surface being associated with an obstacle captured by a user via an image sensor in a mobile device;
receiving an AR generation instruction to generate an AR anchor at a target location; and
modifying an AR placement user interface based on an AR generation area around the target location intersecting the surface.

16. The method of claim 15, further comprising defining a capture instruction displayed via the AR placement user interface based on the AR generation area around the target location.

17. The method of claim 15, further comprising defining the AR generation area such that the AR generation area does not intersect the surface.

18. An apparatus, comprising:
a sensor system configured to capture at least a portion of a real-world area using a mobile device;
a surface identification engine configured to detect a surface within the real-world area;
an anchor generation engine configured to receive an AR generation instruction to generate an AR anchor at a target location within a threshold distance of the surface within the real-world area; and
an adaptive AR placement user interface configured to define a capture instruction, in response to the AR generation instruction and based on the target location being within the threshold distance.

19. The apparatus of claim 18, wherein the capture instruction is modified from a default capture instruction define to scan entirely around the target location.

20. The apparatus of claim 18, wherein the capture instruction includes a capture arc less than 360 degrees.
